(19) United States
(12) Patent Application Publication
(10) Pub. No.: US 2026/0222308 A1
(43) Pub. Date: Jul. 30, 2026

(54) SYSTEM FOR EFFICIENTLY SELECTING USER PLANE FUNCTION (UPF) IN A HIGH SPEED 6G CORE NETWORK AND A PROCESS THEREOF

(71) Applicant: INDIAN INSTITUTE OF TECHNOLOGY KHARAGPUR, Kharagpur (IN)

(72) Inventors: Mr. Nairit Das, Kharagpur (IN); Mr. Kounteya Sarkar, Kharagpur (IN); Mr. Subhendu Ghosh, Kharagpur (IN); Prof. Sudip Misra, Kharagpur (IN); Prof. Aneek Adhya, Kharagpur (IN)

(73) Assignee: INDIAN INSTITUTE OF TECHNOLOGY KHARAGPUR, Kharagpur (IN)

(21) Appl. No.: 19/075,665

(22) Filed: Mar. 10, 2025

(30) Foreign Application Priority Data
Jan. 24, 2025 (IN) 202531006169

(51) Int. Cl. H04L 41/147; H04L 67/60

(52) U.S. Cl. CPC H04L 41/147; H04L 67/60

(57) ABSTRACT

This invention provides system to judicially select user plane function (UPF) from a plurality of user plane functions (UPFs) in a high-speed 6G core network comprising network data analytics function (NWDAF) unit to collect historical energy consumption data of each of the UPFs registered in the network and managing a plurality of user application flows, an energy efficiency module (EEM) integrated within said NWDAF unit to execute a predictive learning process over the collected historical energy consumption data and predict a future energy consumption for each of the UPFs, and selecting that UPF among the plurality of UPF for which the predicted energy consumption is least. The SMF unit provides information of energy consumption of each of the UPFs to the NWDAF unit and further implements a flow allocation mechanism with establishing connection in control plane to anchor a particular UPF for a new flow request as predicted by the EEM which will consume the least energy in a subsequent time interval.

### RELATED APPLICATIONS

This application claims priority to India Patent Application No. 202531006169, Filing Date Jan. 24, 2025, entitled SYSTEM FOR EFFICIENTLY SELECTING USER PLANE FUNCTION (UPF) IN A HIGH SPEED 6G CORE NETWORK AND A PROCESS THEREOF; which is incorporated herein by reference in its entirety.

### FIELD OF THE INVENTION

This invention alms to provide a mechanism for realizing Model training logical function (MTLF) as defined within Network data analytics function (NWDAF) for 6G core network architecture by proposing to incorporate an Energy Efficiency Module (EEM) within NWDAF that executes a predictive learning process which predicts the energy consumption of a plurality of User Plane Functions (UPFs) based on their historical flow statistics and immediate past energy consumption. This enables the system to select the UPF which is predicted to consume the least amount of energy in the next instant for assigning to a new incoming flow. The invention also proposes the correct sequence of the respective service flows to be incorporated within the procedure for UE (User equipment) communication analytics that realizes the proposed MTLF through the EEM.

### BACKGROUND OF THE INVENTION

As per the 5G standards set by 3GPP TS 23.501 [10], it is required that all user data of 5G core must be routed through the UPF NFs which serve as the principle switching entity between the (radio) access network ((R)AN) and the respective destination servers (FIG. 1). The UPFs are responsible for maintaining appropriate routes for each flow, strictly ensuring that the flow characteristics are maintained. For each new flow request that comes from a user equipment (UE), before the data transfer can begin, a specific set of actions are collaboratively executed among various 5G control plane entities that assign a particular UPF to the flow among a plurality of operational UPFs. It is expected that 6G core will also have a similar requirement criterion with respect to UPF selection for each new flow.

In Joint Placement of UPF and Edge Server for 6G Network [1], authors investigated the deployment of UPF in 6G networks. The authors proposed a methodology for UPF placement aimed at minimizing latency while accounting for constraints related to bandwidth, equipment expenses, and infrastructure construction.

In Optimal Placement of User Plane Functions in 5G Networks [2] researchers examined the ideal positioning of UPF by considering latency, reliability, and user mobility.

In Dynamic Scheduling and Optimal Reconfiguration of UPF Placement in 5G Networks [3] authors investigated the dynamic placement of UPFs in conjunction with determining the quantity of UPFs and the mapping of users to UPFs.

In Joint optimization of UPF placement and traffic routing for 5G core network user plane [4] authors investigated UPF placement and proposed a system to reduce energy consumption costs while adhering to user plane latency constraints.

Predictive user plane function (upf) load balancing based on network data analytics [5] used the location of the UE, the current load of the UPF, and the predicted load of UE and UPF.

In User plane function (UPF) selection based on predicted load information [6] author considered the load Information to select the UPF. They used a multiple linear regression model for the prediction.

FIG. 1 shows the 6G system model of the Invention scenario, wherein data flows are requested from different UE that serve as the connection endpoints for different 6G applications such as augmented reality (AR)/virtual reality (VR)/extended reality (XR), social metaverse, internet of things (IoT), and massive machine type communication among others. UEs are connected to the (R)AN, from which the data flows must be routed to destination servers via some anchoring UPFs. The (R)AN is connected to different 6G core NFs, such as SMF, NWDAF, and the UPF via suitable Interfaces. The NFs are also connected with each other through relevant Interfaces. Of special Interest Is the Nnwdaf_MLModelProvision [9] services by NWDAF that lays out the scheme for ML-based analytics and service provisioning to NF consumers. In the following, we discuss UPF, NWDAF, and Nnwdaf_MLModelProvision service.

### User Plane Function (UPF):

The UPF is a crucial NF in the 5G/6G core service-based architecture (SBA) that processes, routes, and transmits user data. UPF serves as a connection point to external internet protocol (IP) networks and acts as a reference point for UE. FIG. 2 illustrates the 3GPP standard 5G core SBA, encompassing multiple network services such as the AMF, SMF, and UPF, among others. These functions can be categorized into control plane functions (e.g., SMF, AMF) and user plane functions, such as UPF. The 3GPP technical document TS 23.501 [10] provides a comprehensive overview of the 5G core architecture including the UPF. UPF employs rapid packet forwarding technology, allowing the 5G/6G core to attain ultra-low latency for diverse user-requested applications. The data flow originating from the UE must traverse the UPF to access the destination server. Additional functionality of UPF includes the packet inspection and the management of quality of service (QoS) for the user plane. Considering all the above-mentioned factors, selecting the appropriate UPF in a real-time environment is crucial for maintaining the QoS of the services. This Invention presents an intelligent method for selecting a UPF while considering the critical factor of energy efficiency for the future 6G core. We have employed a deep neural network (DNN) based LSTM time-series model.

### Network Data Analytics Function (NWDAF):

The NWDAF is a crucial NF under the 3GPP 5G/6G SBA. The architecture for NWDAF is delineated in 3GPP technical document TS 23.288 [7], while the signaling flows for network data analytics are specified in 3GPP TS 29.552 [8]. NWDAF aggregates various types of data from multiple NFs, including the AMF, SMF and the UPF, among others. NWDAF gathers this data and delivers Insights to network operators. NWDAF also collects data from application functions (AF) and operations, administration, and maintenance (OAM) to obtain real-time operational intelligence in the 5G/6G core. FIG. 3 delineates the structure for 5G network automation as per 3GPP TR 23.791 [11], showing the interaction of NWDAF with other NFs, AFs, and OAM within the 5G/6G core. The NWDAF provides various services and interacts with the other network components through application programming interfaces (APIs) as specified in 3GPP TS 29.520 v19.0.0 (2024 September) [9]. NWDAF can provide real-time insights and analytical reports to other NFs through these APIs, helping them to make data-driven decisions.

### Nnwdaf_MLModelProvision Service:

Nnwdaf_MLModelProvision service is one type of NWDAF service that provides ML model data for diverse analytical events to NF service consumers. The reference architecture for Nnwdaf_MLModelProvision service can be obtained from 3GPP TS 29.520 [9].

FIG. 4 shows the signaling flow to enable Nnwdaf_MLModelProvision service following 3GPP TS 29.552 [8] while the FIG. 4A shows Procedure for UE communication analytics 3GPP TS 29.552 v19.0.0 (2024 September), FIG. 5.7.7-1 [8]. The above-mentioned procedure is employed by an NF service consumer to subscribe for (or unsubscribe from) the ML model for analytics on NWDAF MTLF. Additionally, the NWDAF uses the above-mentioned procedure to notify the NF service consumer of the ML model information if it has previously subscribed to the ML model information.

The Nnwdaf_MLModelProvision service flow diagram is discussed below:
1. To subscribe ML model information, the NF service consumer executes the Nnwdaf_MLModelProvision_Subscribe service.
2. The NWDAF (which includes MTLF) responds to the Nnwdaf_MLModelProvision_Subscribe service action.
3. When information is available, the NWDAF MTLF invokes the Nnwdaf_MLModelProvision_Notify service action.
4. The NF service consumer replies to the NWDAF, with a “No Content” response.
5. To unsubscribe from notifications regarding ML model information, the NF service consumer executes the Nnwdaf_MLModelProvision_Unsubscribe request.

Upon acceptance of the request, the NWDAF removes the subscription and replies to the NF service consumer with a “No Content” response.

3GPP technical documents TS 29.552 v19.0.0 (2024 September), clause 5.6 [8] is also referred for more details and specifications.

### REFERENCES

[1]Y. Li et al., “Joint Placement of UPF and Edge Server for 6G Network,” in IEEE Internet of Things Journal, vol. 8, no. 22, pp. 16370-16378, 15 Nov. 15, 2021, doi: 10.1109/JIOT.2021.3095236.
[2] Irian Leyva-Pupo, Cristina Cervelló-Pastor, and Alejandro Llorens-Carrodeguas. 2019. “Optimal Placement of User Plane Functions in 5G Networks.” In Wired/Wireless Internet Communications: 17th IFIP WG 6.2 International Conference, WWIC 2019, Bologna, Italy, Jun. 17-18, 2019, Proceedings. Springer-Verlag, Berlin, Heidelberg, 105-117. https://doi.org/10.1007/978-3-030-30523-9_9
[3] Irian Leyva-Pupo, Cristina Cervelló-Pastor, Christos Anagnostopoulos, and Dimitrios P. Pezaros. 2020. “Dynamic Scheduling and Optimal Reconfiguration of UPF Placement in 5G Networks.” In Proceedings of the 23rd International ACM Conference on Modeling, Analysis and Simulation of Wireless and Mobile Systems (MSWiM '20). Association for Computing Machinery, New York, NY, USA, 103-111. https://doi.org/10.1145/3416010.3423221
[4] Songyan Chen, Junjie Chen, Hongjun Li, “Joint optimization of UPF placement and traffic routing for 5G core network user plane”, Computer Communications, Volume 216, 2024, Pages 86-94, ISSN 0140-3664, https://doi.org/10.1016/j.comcom.2023.12.029
[5]S. C. Kazi BASHIR, Mehdi Alasti, “Predictive user plane function (upf) load balancing based on network data analytics.” https://patents.google.com/patent/WO2023091352A1/en. [Accessed 29 Nov. 2024].
[6]A. G. R. S. V. O. P. S. Bincy Baburaj Narath, Padmaraj Ramanoudjam, “User plane function (UPF) selection based on predicted load information.”
https://patents.google.com/patent/US20210219179A1/en. [Accessed 29 Nov. 2024].
[7]“Architecture enhancements for 5G System (5GS) to support network data analytics services”, 3GPP TS 23.288, version 19.0.0, 2024.
[8]“5G System; Network Data Analytics signalling flows; Stage 3”, 3GPP 29.552, version 19.0.0, 2024.
[9]“5G System; Network Data Analytics Services; Stage 3”, 3GPP 29.520, version 19.0.0, 2024.
[10]“System architecture for the 5G System (5GS)”, 3GPP 23.501, version 16.6.0, 2020.
[11]“Study of enablers for Network Automation for 5G”, 3GPP TR 23.791 version 16.2.0, 2019.
[12]A. Vishwanath, F. Jalali, R. Ayre, T. Alpcan, K. Hinton and R. S. Tucker, “Energy consumption of interactive cloud-based document processing applications,” 2013 IEEE International Conference on Communications (ICC), Budapest, Hungary, 2013, pp. 4212-4216, doi: 10.1109/ICC.2013.6655224.
[13]A. Vishwanath, F. Jalali, K. Hinton, T. Alpcan, R. W. A. Ayre and R. S. Tucker, “Energy Consumption Comparison of Interactive Cloud-Based and Local Applications,” in IEEE Journal on Selected Areas in Communications, vol. 33, no. 4, pp. 616-626, April 2015, doi: 10.1109/JSAC.2015.2393431.

### OBJECT OF THE INVENTION

It Is thus the basic object of the present invention is to provide a mechanism for realizing Model training logical function (MTLF) as defined within Network data analytics function (NWDAF) for 6G core network architecture by incorporating an Energy Efficiency Module (EEM) within NWDAF that executes a predictive learning process which predicts the energy consumption of a plurality of User Plane Functions (UPFs) based on their historical flow statistics and immediate past energy consumption.

Another object of the present invention is to develop system, architecture and methodology to select the best UPF among a plurality of available UPFs for assignment of a new application flow request ensuring the selected UPF will consume the least amount of energy in the next interval.

Another object of the present invention is to introduce an energy consumption analytics through an energy efficiency module (EEM) incorporated with the existing NWDAF modularity.

Yet another object of the present invention is to implement the “Nnwdaf_MLModelProvision” service into the “Procedure for UE Communication analytics” through appropriate sequential service flows by integrating the EEM within NWDAF.

### SUMMARY OF THE INVENTION

Thus, according to the basic aspect of the present invention there is provided a system for selecting a user plane function (UPF) in a high-speed 6G core network that minimize energy consumption comprising:
a network data analytics function (NWDAF) unit to collect historical energy consumption data of each of the UPFs registered in the network and managing a plurality of user application flows, said NWDAF unit collects information regarding the energy consumption of the each UPFs from a session management function (SMF) unit;
an energy efficiency module (EEM) Integrated within said NWDAF unit to execute a predictive learning process over the collected historical energy consumption data and predict a future energy consumption for each of the UPFs including selecting the UPF which is predicted to consume least energy in a subsequent time interval;
a session management function (SMF) unit for establishing communication between the EEM within the NWDAF unit and the UPF, said SMF unit provides information of energy consumption of each of the UPFs to the NWDAF unit and further implements a flow allocation mechanism with establishing connection in control plane to anchor said selected UPF as predicted by the EEM which will consume the least energy in the subsequent time interval for a new flow request.

In the above system, the SMF unit provided information to the NWDAF unit includes comprehensive historical energy consumption data of all the flows that a given UPF manages along with details such as the nature and type of flow application, data rate, flow start time, and flow completion time;
wherein the NWDAF unit maintains a list of total energy consumed by each UPF for processing all flows by that UPF, sampled at a regular time interval.

In the above system, the EEM employs long short-term memory (LSTM) based predictive process which is based on a deep neural network (DNN) to provide time-series-based predictive analysis for executing time-series-based forecasting on the energy consumption data and thus selecting the UPF based on predicted energy consumption;
wherein said DNN based LSTM predictive process is trained on a sliding window of historical energy consumption data, whereby size of said window is configurable by a network administrator.

In the above system, the NWDAF unit is configured to exchange messages with the SMF, UPF, and access and mobility function (AMF) to facilitate communication and data flow relevant to energy consumption monitoring and UPF selection.

In the above system, the NWDAF provides “Nnwdaf_MLModelProvision” service to allow the EEM for the LSTM-based predictive capability including incorporating “Nnwdaf_MLModelProvision_Subscribe request” and “Nnwdaf_MLModelProvision_Subscribe response” into sequence numbers (1b: FIG. 5) and (1c: FIG. 5) respectively;
including “Nnwdaf_MLModelProvision_Notify request” with sequence numbers (13a: FIG. 5) and (20a: FIG. 5), and “Nnwdaf_MLModelProvision_Notify response” with sequence numbers (13b: FIG. 5) and (20b: FIG. 5), respectively;
wherein, per signaling flows of (1b: FIG. 5) and (1c: FIG. 5), to acquire ML model information pertinent to UE communication analytics (provided by NWDAF), NF service consumer invoke “Nnwdaf_MLModelProvision_Subscribe request” and the NWDAF may respond with “Nnwdaf_MLModelProvision_Subscribe response”;
wherein upon execution of steps (1b: FIG. 5) and (1c: FIG. 5), the NWDAF initiate “Nnwdaf_MLModelProvision_Notify request” and “Nnwdaf_MLModelProvision_Notify response” as given in (13b: FIG. 5) and (13c: FIG. 5), whereby these services are invoked once again by NWDAF in (20b: FIG. 5) and (20c: FIG. 5).

In the above system, the EEM supports dynamic adjustments in the sampling interval for energy consumption data based on application type, including but not limited to augmented reality (AR), virtual reality (VR), massive IoT, and social metaverse applications;
wherein the sampling interval can be varied dynamically by network administrator as per any rules as mandated by real-time conditions and/or business logic.

According to a further aspect in the present invention there is provided a process for selecting a user plane function (UPF) node for allocating a new user application flow in a communication network, comprising the steps of:
receiving historical energy consumption data from a plurality of UPF nodes in the network as managed by a session management function (SMF) unit;
using an energy efficiency module (EEM) Integrated within a network data analytics function (NWDAF) to predict energy consumption for each UPF node over a future time interval, based on the received historical energy consumption data;
selecting the UPF node predicted to consume the least energy for the upcoming time interval;
allocating the selected UPF node to the new user application flow request; and establishing communication between the new user flow and the selecting UPF node for processing.

In the above process, the historical consumption data includes flow-specific information such as flow type, data rate, flow start time, and flow end time, and further wherein the historical energy consumption data for each UPF is sampled at regular time intervals and maintained by the EEM.

In the above process, the EEM executes time-series predictive process including a long short-term memory (LSTM) network the historical energy consumption data to predicts the future energy consumption data, whereby the LSTM network is trained using the historical energy consumption data from the plurality of UPF nodes.

In the above process, the historical energy consumption data is sampled at regular time intervals, and the sampling interval is adjustable based on network requirements and the type of user applications, including augmented reality (AR), virtual reality (VR), extended reality (XR), and massive Internet of Things (IoT) applications.

### BRIEF DESCRIPTION OF THE DRAWINGS

FIG. 1: 6G System Model.

FIG. 2: 3GPP standard 5G core service-based architecture.

FIG. 3: General framework for 5G network automation as described in 3GPP TR 23.791 v16.2.0 (2019 June) [11].

FIG. 4: Nnwdaf_MLModelProvision service signaling flow (3GPP TS 29.552) [8].

FIG. 4A Procedure for UE communication analytics 3GPP TS 29.552 v19.0.0 (2024 September), FIG. 5.7.7-1 [8]

FIG. 5: Proposed procedure for UE communication analytics with Nnwdaf_MLModelProvision

FIG. 5A Single LSTM cell structure.

FIG. 6: Power consumption trend [12][13].

FIG. 7: Epochs curve vs. train and validation loss.

FIG. 8: Train and test prediction using LSTM model.

FIG. 9: Train and test prediction plot using LSTM model.

FIG. 10: Mean absolute error vs. the number

FIG. 11: Mean absolute error vs. the number of epochs of hidden layers.

FIG. 12: Mean absolute error vs. the number of time steps.

### DETAILED DESCRIPTION OF THE INVENTION

With high-speed traffic flow through sixth-generation (6G) core networks, the efficient selection of a user plane function (UPF) node to which a new flow would be allocated to improve energy efficiency is a critical issue. Towards this, the current invention proposes a system, architecture, and methodology for efficient UPF selection to a new user application flow based on the predictive energy consumption analysis using the services from the network data analytics function (NWDAF) [8]. The NWDAF unit is an essential component of the fifth-generation (5G) core service-based architecture (SBA), as specified in the third-generation partnership project (3GPP) technical document TS 23.288 [7]. Specifically, the invention proposes the introduction of an energy efficiency module (EEM) to be integrated with the existing NWDAF unit that executes sophisticated learning processes over the historical energy consumption data. We also propose the procedure to exchange the relevant set of messages between the NWDAF unit and the other network function(s) (NFs), such as session management function (SMF) unit, UPF, and access and mobility function (AMF) units to facilitate the implementation of the EEM module.

The proposed invention is aimed at improving the “Procedure for UE communication analytics [8] with the integration of Nnwdaf_MLModelProvision service [8][9]” within the future 6G service level agreement (SLA) framework as defined in the 3GPP technical document TS 29.552 v19.0.0 (2024 September) [8]. When a new flow request arrives, connection establishment occurs in the control plane, and the SMF is used to anchor a particular UPF to the request. In order to achieve this, the EEM continuously executes a time series-based learning process that predicts the energy consumption in the next interval slot for all UPFs based on the previous sampled values of energy expended for each UPF. The NWDAF receives information from the SMF on the amount of energy consumption by each UPF registered with the network for all the flows that the UPF manages. This information includes comprehensive historical data (sampled at a regular time interval) of all the flows that a given UPF manages, including details such as the nature and type of flow application, data rate, flow start time, and flow completion time. For each such UPF, the EEM collects the data and computes the energy expended for each flow. The UPF which is predicted to consume the least energy in the next interval is chosen to be the anchor UPF for the new flow, and accordingly the UPF is assigned. This invention uses long-short term memory (LSTM) based predictive process; however, the EEM is proposed to support any other suitable process that may provide time-series-based predictive analysis.

Furthermore, we have suggested modifications to the signaling flow handled by different NFs (including NWDAF). The model training logical function (MTLF) that operates inside NWDAF offers various services to facilitate the machine learning (ML) services. We propose integration of the Nnwdaf_MLModelProvision service [8][9] to enable LSTM-based predictive capability.

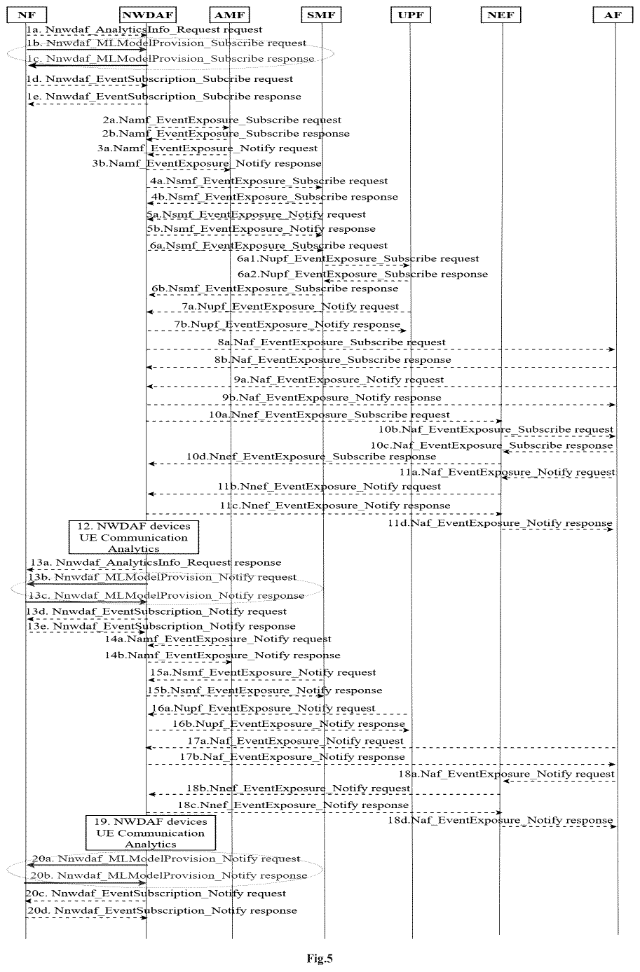

In this invention, our solution works on the “Nnwdaf_MLModelProvision” service by proposing necessary modifications to the service flow sequences as detailed in FIG. 5.7.7-1 titled “Procedure for UE Communication Analytics”, in 3GPP TS 29.552 v19.0.0 (2024 September) [8]. FIG. 5 displays the proposed placement of Nnwdaf_MLModelProvision signaling flows within the “Procedure for UE Communication Analytics” signaling hierarchy (highlighted by an oval box). Specifically, we propose to incorporate “Nnwdaf_MLModelProvision_Subscribe request” and “Nnwdaf_MLModelProvision_Subscribe response” into the sequence numbers (1b) and (1c) of FIG. 5 respectively. We include “Nnwdaf_MLModelProvision_Notify request” with sequence numbers (13a) and (20a), and “Nnwdaf_MLModelProvision_Notify response” with sequence numbers (13b) and (20b), respectively. As per signaling flows of (1b) and (1c), to acquire the ML model information pertinent to UE communication analytics (provided by NWDAF), the NF service consumer may invoke “Nnwdaf_MLModelProvision_Subscribe request” and the NWDAF may respond with “Nnwdaf_MLModelProvision_Subscribe response”. Upon the execution of steps (1b) and (1c), the NWDAF may initiate “Nnwdaf_MLModelProvision_Notify request” and “Nnwdaf_MLModelProvision_Notify response” as given in (13b) and (13c). These services are invoked once again by NWDAF in (20b) and (20c). The proposed sequential placement of the signaling flow between NWDAF and NF realize the analytic services of NWDAF within the future 6G core.

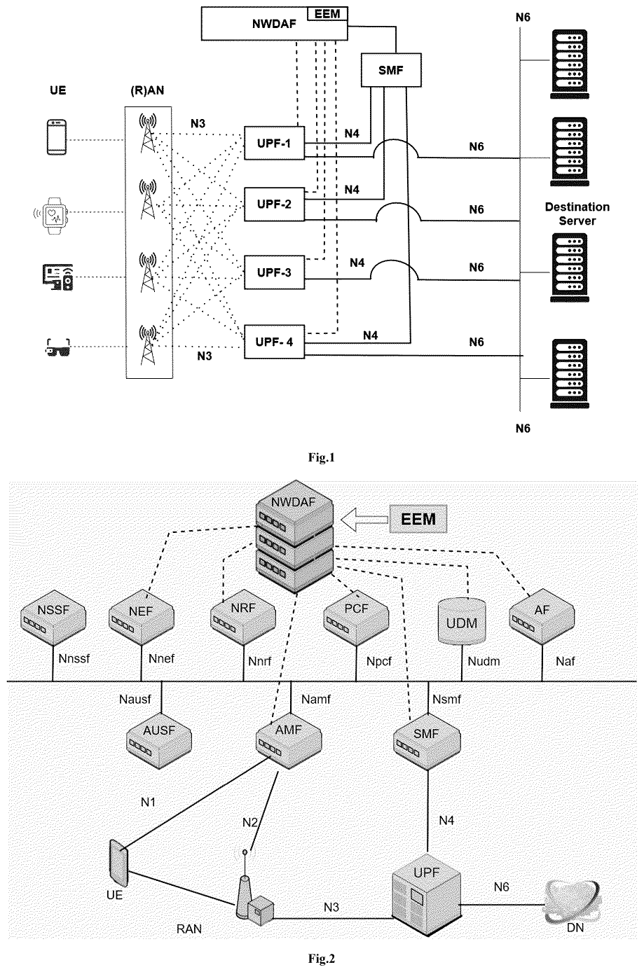

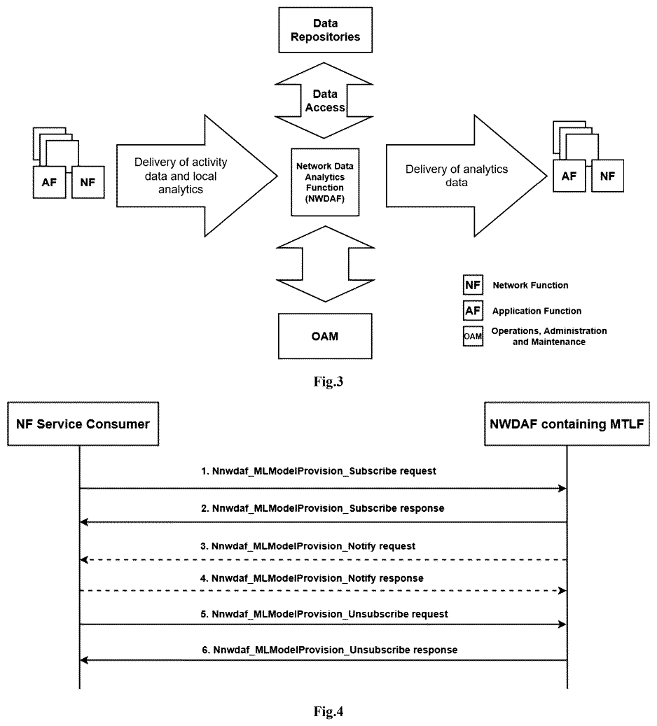

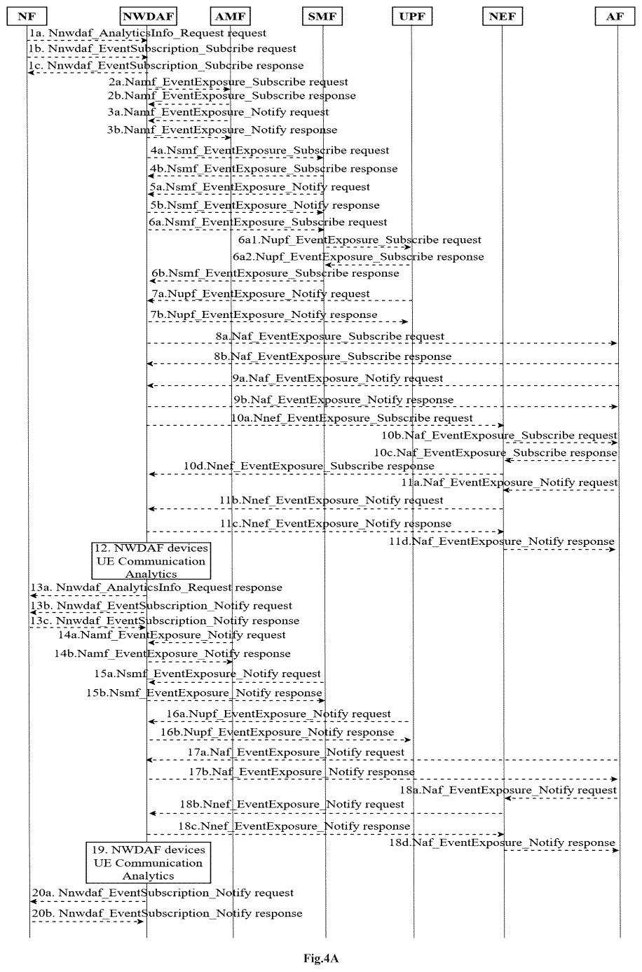

Secondly, the invention also proposes the introduction of an intelligent module named EEM to the present NWDAF modularity structure that implements the MTLF functionalities. The EEM within NWDAF collects historical data from each of the UPFs associated with the network through the SMF, and maintains a list of the total amount of energy consumed by each UPF at regular time intervals. FIG. 2 displays the architecture of the proposed EEM module within NWDAF, based on the future 6G service-based core architecture. EEM interfaces with UPF via NWDAF and SMF with the help of appropriate service-based interfaces. Table III shows a sample tabular record of the amount of energy consumption, that EEM maintains for a given UPF for all the flows that the UPF processes. Each row represents a flow with its time-in and time-out (wherein their difference represents the resident time for the flow within the UPF). EEM maintains similar records for all UPFs registered in the system. From this information, the EEM samples the total energy consumed for all the flows at regular interval for each UPF. Table IV shows the sampled energy consumption for UPF 1 for every 5 minutes of interval obtained from Table III. Tables V, VI, and VII (Appendix IV) show similar sampled energy values for UPF 2, 3, and 4. The sampling interval maintained by EEM may vary as per the network requirements and the management decisions. The sampling interval may also depend on the application type being processed by UPF, such as AR, VR, XR, social metaverse, massive IoT, and others. The EEM continuously executes a predictive learning process on its maintained list of energy consumption data for each UPF, and selects the UPF for which the predicted energy consumption in the next interval is the least. The selected UPF is then allocated as the anchor UPF for the incoming flow request.

The EEM collects flow and energy consumption data for all UPFs and samples the energy consumption data at regular interval, which is used to predict the UPF with the least energy consumption for the subsequent interval. The UPF is assigned for the next incoming flow request. The invention proposes to employ deep neural network (DNN) based LSTM as the intelligent predictive process. The LSTM model resides on the EEM, wherein it continuously trains on the total energy consumption data for each UPF sampled at regular interval (Tables IV, V, VI and VII for UPFs 1, 2, 3, and 4, respectively).

The model selects the energy consumption values of the last few intervals for a given window size and predicts the output energy consumption value for the next interval for each UPF. The window size is flexible and can be set by the administrator. As new data arrives from the SMF to the EEM, the LSTM based model Is re-trained to fit the latest data in accordance with the window size. The resident LSTM on the EEM provides the MTLF service provisioning over NWDAF and realizes a system and mechanism for enabling “Nnwdaf_MLModelProvision” service.

Time-series forecasting and future step prediction can benefit from the use of LSTM networks, a unique kind of recurrent neural network (RNN) that is made to learn long-term dependencies. Standard RNNs experience vanishing and exploding gradient issues, which limit their capacity to capture long-term dependencies. LSTM addresses this issue by incorporating memory cells and gating mechanisms that allow for the retention of information over prolonged time periods.

The FIG. 5A shows the deep learning model known as LSTM utilized in present work. An LSTM cell comprises three gates: the input gate (iₜ), the forget gate (fₜ), and the output gate (oₜ), in addition to a cell state (Cₜ) and a hidden state (hₜ). These elements regulate the information flow within the cell, dictating what information should be preserved, modified, or discarded. The gates are shown as sigmoid activation functions (σ). The weights connecting the input (xₜ) to the hidden layer (hₜ) are denoted by matrix U, while the recurrent connection weights between the preceding hidden layer (hₜ₋₁) and the current layer (hₜ) are represented by matrix W. The Hadamard product is represented as ‘∘’.

The forget gate is represented as fₜ=σ(W_{f}hₜ₋₁+U_{f}xₜ+b_{f}).

The input gate is represented as iₜ=σ(Wᵢhₜ₋₁+Uᵢxₜ+bᵢ).

The output gate is represented as oₜ=σ(Wₒhₜ₋₁+Uₒxₜ+bₒ).

The cell input activation with tanh is given as \tilde{C}ₜ=tanh(W_{\tilde{C}}hₜ₋₁+U_{\tilde{C}}xₜ+b_{\tilde{C}}).

The cell activation vector Cₜ is computed utilizing the forget gate action with the previous cell activation vector Cₜ₋₁ and the input gate operation with the cell input activation vector \tilde{C}ₜ as

$${C}_{t} = {f}_{t} \cdot {C}_{t - 1} + {i}_{t} \cdot {\tilde{C}}_{t} .$$

The new output is determined as hₜ=o_{f}∘tanh (Cₜ) The LSTM residing within the EEM takes as input the historical value of the total energy consumed for each UPF associated with the network. Specifically, the historical energy consumption data is presented as a relational table containing the total energy consumed by each UPF for processing flows at every 5 minute interval. The sampling interval of 5 minutes is not fixed, rather it may be varied as per the network administrator. Table IV, V, VI and VII displays the sample input tables for four different UPFs, which act as input to the LSTM. With the data of the last few sampling intervals available, the LSTM predicts the most probable energy consumption value for each UPF for the next time interval. The input data to the LSTM thus represents the physical energy consumed by each UPF at every 5 minute interval. The LSTM inputs Table IV, V, VI and VII are further generated by the EEM from the complete list of all flows that each UPF processes, which contains additional data such as the time of arrival of the flow, time of departure of the flow and the energy consumed for that particular flow. Table III displays a sample flow processing data set for a single UPF (UPF-1). Similar data are available for other UPFs as well. These data are maintained by the NWDAF, which it receives from each UPF through the SMF. The EEM generates the LSTM inputs from the flow processing dataset for each UPF as maintained by NWDAF.

Further, with respect to the procedure of the present invention, the NWDAF and the EEM within it can be thought as network functions configured over any standard networking hardware with sufficient computing and processing power, such as server computers. The UPFs are also network functions that can be configured over any general purpose computing machines such as servers.

### Energy Consumption Model:

In references [12] and [13], A. Vishwanath et al. describe incremental energy per bit of network equipment like core routers, edge routers, and Ethernet switches.

FIG. 6 illustrates the power consumption patterns of network components. P₀ denotes the idle power consumption of networking devices (e.g., a core router); P_{c} signifies the power consumption at a data rate of C bits/sec, and the maximum power consumption is expressed as Pₜ for Cₜ bits/sec. We can express the slope m, which represents incremental energy per bit, as m=(Pₜ−P₀)/Cₜ. Table I presents a representative example below [12].

TABLE I
Network equipment and incremental energy per bit [12]

| | | Max | Max | Idle | Incremental |
|---|---|---|---|---|---|
| | | capacity | power | power | energy per |
| Type | Model | (Cₜ) | (Pₜ) | (P₀) | bit (slope m) |
| Core | CRS-3 | 4480 Gbps | 12300 W | 9840 W | 0.5 nJ/bit |
| Router | | | | | |
| Edge | 7609 | 560 Gbps | 4550 W | 3640 W | 1.6 nJ/bit |
| Router | | | | | |

We have assumed that the UPF runs on this type of networking device (for instance, the core router CRS-3). The network administrator can adjust the value of ‘m’ in accordance with the device specifications. Our energy usage framework is as follows:

$$e = ( r \times m \times t ) + {k}_{0}$$

The total amount of energy consumption for a particular flow, denoted by “e,” is calculated by multiplying the data rate (r) (in bits/sec), the energy per bit (m) (in nJ/bit), and the time the flow was in the device (t) (in seconds). Moreover, the idle energy consumption is represented by k₀ (J).

### Results and Discussion:

We consider the 6G core comprises four UPFs. We set the following parameters of the LSTM model as shown in Table II. The learning rate is set at 0.00001, with 125 epochs, a step size of 70, a batch size of 64, 200 neurons per layer, and 2 hidden layers, utilizing the Adam optimizer.

TABLE II
LSTM model parameters

| Sl. No. | Parameters | Values |
|---|---|---|
| 1 | Learning rate | 0.00001 |
| 2 | Epochs | 125 |
| 3 | Steps | 70 |
| 4 | Batch size | 64 |
| 5 | Number of neurons per layer | 200 |
| 6 | Number of hidden layers | 2 |
| 7 | Optimizer | Adam |

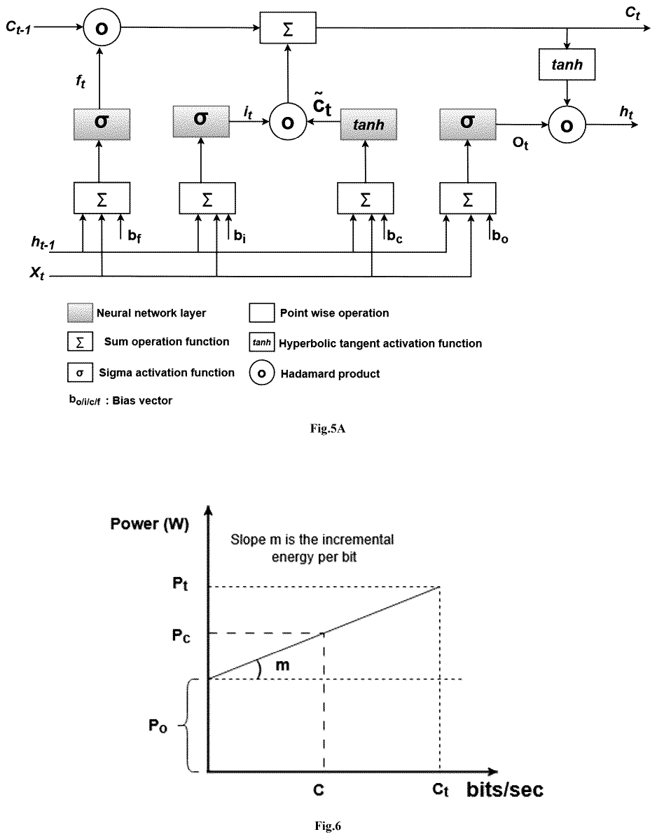

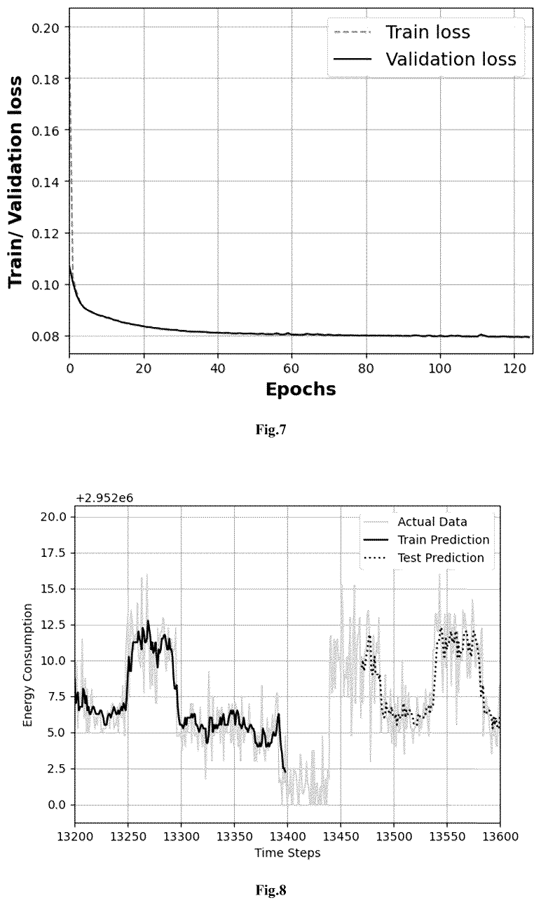

FIG. 7 illustrates the training loss and validation loss curves in relation to the number of epochs. The train score of mean absolute error (MAE) is 1.24 while the test score of MAE is 1.24.

FIG. 8 illustrates the prediction plot for both the training and testing phases along with actual data of the LSTM model.

FIG. 9 illustrates the prediction plot for both the training and testing phases using LSTM model.

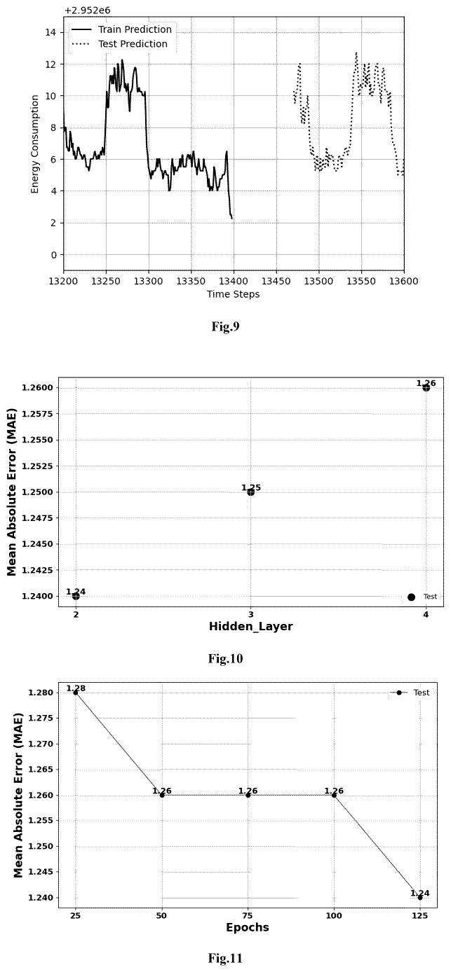

FIG. 10 illustrates the MAE values for the model across various configurations of hidden layers. The error value is the minimum when two hidden layers are utilized.

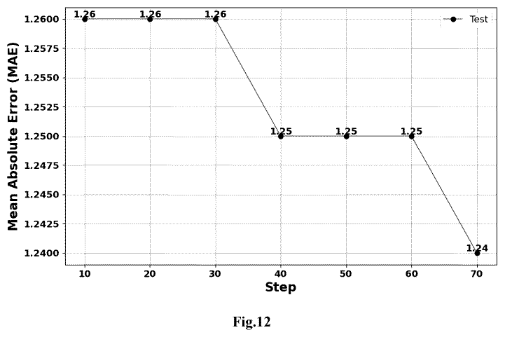

FIG. 11 illustrates the MAE values with variation in the number of epochs. It has been noticed that as the number of epochs increases, the inaccuracy diminishes.

FIG. 12 illustrates the MAE values with variation in the number of time steps. We have conducted tests for 10, 20, . . . , 70 steps and noted that the MAE diminishes as the number of time steps increases.

TABLE III
(UPF-1): Energy consumption table with time in and time
out for different flows without idle energy consumption

| | | | Energy |
|---|---|---|---|
| Date | Time In | Time Out | Consumption |
| Jan. 1, 2024 | 06:00:00 | 06:00:45 | 2.204505 |
| Jan. 1, 2024 | 06:01:00 | 06:01:41 | 2.019763 |
| Jan. 1, 2024 | 06:02:00 | 06:02:54 | 2.678184 |
| Jan. 1, 2024 | 06:03:00 | 06:04:14 | 3.67188 |
| Jan. 1, 2024 | 06:04:00 | 06:04:44 | 2.187944 |
| Jan. 1, 2024 | 06:05:00 | 06:06:10 | 3.42923 |
| Jan. 1, 2024 | 06:06:00 | 06:07:01 | 2.946422 |
| Jan. 1, 2024 | 06:07:00 | 06:07:44 | 2.02983 |
| Jan. 1, 2024 | 06:08:00 | 06:09:04 | 2.702432 |
| Jan. 1, 2024 | 06:09:00 | 06:10:05 | 3.215095 |
| . . . | . . . | . . . | . . . |

Table IV, V, VI, VII: Energy Consumption Values with Five-Minute Intervals with the Idle Energy Consumption for Five-Minute Intervals.

TABLE IV
(UPF-1)

| Interval Start | Total Energy |
|---|---|
| 01-01-2024 06:30 | 2952009.914 |
| 01-01-2024 06:35 | 2952012.856 |
| 01-01-2024 06:40 | 2952010.285 |
| 01-01-2024 06:45 | 2952009.917 |
| 01-01-2024 06:50 | 2952004.384 |
| 01-01-2024 06:55 | 2952015.239 |
| 01-01-2024 07:00 | 2952009.929 |
| . . . | . . . |

TABLE V
(UPF-2)

| Interval Start | Total Energy |
|---|---|
| 01-01-2024 08:55 | 2952013.051 |
| 01-01-2024 09:00 | 2952015.412 |
| 01-01-2024 09:05 | 2952012.92 |
| 01-01-2024 09:10 | 2952012.177 |
| 01-01-2024 09:15 | 2952013.76 |
| 01-01-2024 09:20 | 2952011.292 |
| 01-01-2024 09:25 | 2952010.038 |
| . . . | . . . |

TABLE VI
(UPF-3)

| Interval Start | Total Energy |
|---|---|
| 25-01-2024 01:25 | 2952013.742 |
| 25-01-2024 01:30 | 2952015.182 |
| 25-01-2024 01:35 | 2952003.96 |
| 25-01-2024 01:40 | 2952009.823 |
| 25-01-2024 01:45 | 2952015.16 |
| 25-01-2024 01:50 | 2952009.43 |
| 25-01-2024 01:55 | 2952006.67 |
| . . . | . . . |

TABLE VII
(UPF-4)

| Interval Start | Total Energy |
|---|---|
| 04-02-2024 14:15 | 2952007.597 |
| 04-02-2024 14:20 | 2952005.296 |
| 04-02-2024 14:25 | 2952004.229 |
| 04-02-2024 14:30 | 2952004.958 |
| 04-02-2024 14:35 | 2952004.265 |
| 04-02-2024 14:40 | 2952005.395 |
| 04-02-2024 14:45 | 2952002.305 |
| . . . | . . . |

| Notation | Description |
|---|---|
| 3GPP | Third-generation partnership project |
| 5G | Fifth generation |
| 6G | Sixth generation |
| AF | Application function |
| AMF | Access and mobility function |
| API | Application programming interface |
| AR | Augmented reality |
| AUSF | Authentication server function |
| DNN | Deep neural network |
| EEM | Energy efficiency module |
| LSTM | Long short-term memory |
| MAE | Mean absolute error |
| MTLF | Model training logical function |
| NEF | Network exposure function |
| NF | Network function |
| NRF | Network repository function |
| NSSF | Network slice selection function |
| NWDAF | Network data analytics function |
| OAM | Operation administration and maintenance |
| PCF | Policy control function |
| RAN | Radio access network |
| RNN | Recurrent neural network |
| SBA | Service based architecture |
| SBI | Service based interface |
| SLA | Service level agreement |
| SMF | Session management function |
| UDM | Unified data management function |
| UE | User equipment |
| UPF | User plane function |
| VR | Virtual reality |
| XR | Extended reality |

1. A system for selecting a user plane function (UPF) in a high-speed 6G core network that minimize energy consumption comprising:
a network data analytics function (NWDAF) unit to collect historical energy consumption data of each of the UPFs registered in the network and managing a plurality of user application flows, said NWDAF unit collects information regarding the energy consumption of the each UPFs from a session management function (SMF) unit;
an energy efficiency module (EEM) integrated within said NWDAF unit to execute a predictive learning process over the collected historical energy consumption data and predict a future energy consumption for each of the UPFs including selecting the UPF which is predicted to consume least energy in a subsequent time interval;
a session management function (SMF) unit for establishing communication between the EEM within the NWDAF unit and the UPF, said SMF unit provides information of energy consumption of each of the UPFs to the NWDAF unit and further implements a flow allocation mechanism with establishing connection in control plane to anchor said selected UPF as predicted by the EEM which will consume the least energy in the subsequent time interval for a new flow request.

2. The system as claimed in claim 1, wherein the SMF unit provided information to the NWDAF unit includes comprehensive historical energy consumption data of all the flows that a given UPF manages along with details such as the nature and type of flow application, data rate, flow start time, and flow completion time;
wherein the NWDAF unit maintains a list of total energy consumed by each UPF for processing all flows by that UPF, sampled at a regular time interval.

3. The system as claimed in claim 1, wherein the EEM employs long short-term memory (LSTM) based predictive process which is based on a deep neural network (DNN) to provide time-series-based predictive analysis for executing time-series-based forecasting on the energy consumption data and thus selecting the UPF based on predicted energy consumption;
wherein said DNN based LSTM predictive process is trained on a sliding window of historical energy consumption data, whereby size of said window is configurable by a network administrator.

4. The system as claimed in claim 1, wherein the NWDAF unit is configured to exchange messages with the SMF, UPF, and access and mobility function (AMF) to facilitate communication and data flow relevant to energy consumption monitoring and UPF selection.

5. The system as claimed in claim 1, wherein the NWDAF unit provides “Nnwdaf_MLModelProvision” service to allow the EEM for the LSTM-based predictive capability including
incorporating “Nnwdaf_MLModelProvision_Subscribe request” and “Nnwdaf_MLModelProvision_Subscribe response” into sequence numbers (1b: FIG. 5) and (1c: FIG. 5) respectively;
including “Nnwdaf_MLModelProvision_Notify request” with sequence numbers (13a: FIG. 5) and (20a: FIG. 5), and “Nnwdaf_MLModelProvision_Notify response” with sequence numbers (13b: FIG. 5) and (20b: FIG. 5), respectively;
wherein, per signaling flows of (1b: FIG. 5) and (1c: FIG. 5), to acquire ML model information pertinent to UE communication analytics (provided by NWDAF), NF service consumer invoke “Nnwdaf_MLModelProvision_Subscribe request” and the NWDAF may respond with “Nnwdaf_MLModelProvision_Subscribe response”;
wherein upon execution of steps (1b: FIG. 5) and (1c: FIG. 5), the NWDAF initiate “Nnwdaf_MLModelProvision_Notify request” and “Nnwdaf_MLModelProvision_Notify response” as given in (13b: FIG. 5) and (13c: FIG. 5), whereby these services are invoked once again by NWDAF in (20b: FIG. 5) and (20c: FIG. 5).

6. The system as claimed in claim 1, wherein the EEM supports dynamic adjustments in the sampling interval for energy consumption data based on application type, including but not limited to augmented reality (AR), virtual reality (VR), massive IoT, and social metaverse applications;
wherein the sampling interval can be varied dynamically by network administrator as per any rules as mandated by real-time conditions and/or business logic.

7. A process for selecting a user plane function (UPF) node for allocating a new user application flow in a communication network, comprising the steps of:
receiving historical energy consumption data from a plurality of UPF nodes in the network as managed by a session management function (SMF) unit;
using an energy efficiency module (EEM) integrated within a network data analytics function (NWDAF) to predict energy consumption for each UPF node over a future time interval, based on the received historical energy consumption data;
selecting the UPF node predicted to consume the least energy for the upcoming time interval;
allocating the selected UPF node to the new user application flow request; and
establishing communication between the new user flow and the selecting UPF node for processing.

8. The process as claimed in claim 7, wherein the historical consumption data includes flow-specific information such as flow type, data rate, flow start time, and flow end time, and further wherein the historical energy consumption data for each UPF is sampled at regular time intervals and maintained by the EEM.

9. The process as claimed claim 7, wherein the EEM executes time-series predictive process including a long short-term memory (LSTM) network the historical energy consumption data to predicts the future energy consumption data, whereby the LSTM network is trained using the historical energy consumption data from the plurality of UPF nodes.

10. The process as claimed in claim 9, wherein the historical energy consumption data is sampled at regular time intervals, and the sampling interval is adjustable based on network requirements and the type of user applications, including augmented reality (AR), virtual reality (VR), extended reality (XR), and massive Internet of Things (IoT) applications.
